(19) United States
(12) Patent Application Publication
(10) Pub. No.: US 2019/0072758 A1
(43) Pub. Date: Mar. 7, 2019

(54) TWO-DIMENSIONAL LIGHT DEFLECTOR

(71) Applicant: OLYMPUS CORPORATION, Tokyo (JP)

(72) Inventor: Kenji MURAKAMI, Hino-shi (JP)

(73) Assignee: OLYMPUS CORPORATION, Tokyo (JP)

(21) Appl. No.: 16/179,243

(22) Filed: Nov. 2, 2018

Related U.S. Application Data
(63) Continuation of application No. PCT/JP2016/063665, filed on May 6, 2016.

(51) Int. Cl. G02B 26/10; G02B 26/08

(52) U.S. Cl. CPC G02B 26/101; G02B 26/0841; G02B 26/105

(57) ABSTRACT

A two-dimensional light deflector includes first and second deflectors that deflects a light beam, and a fixing member directly fixing both the first and second deflectors. The first deflector includes a light radiating portion, supported oscillatably around a first axis, to radiate the light beam toward the first axis along a first plane perpendicular to the first axis. The second deflector includes an oscillatable reflecting face that reflects the light beam. The reflecting face is inclined by 45 degrees to the first axis and a second axis coincident with a principal ray of the light beam from the radiating portion. The reflecting face is oscillatably supported around a third axis passing through an intersection of the first and second axes and perpendicular to both the first and second axes.

### CROSS-REFERENCE TO RELATED APPLICATIONS

This application is a Continuation Application of PCT Application No. PCT/JP2016/063665, filed May 6, 2016, the entire contents of which are incorporated herein by reference.

### BACKGROUND OF THE INVENTION

### 1. Field of the Invention

The present invention relates to a two-dimensional light deflector that two-dimensionally deflects a light beam.

### 2. Description of the Related Art

Two-dimensional light deflectors that two-dimensionally deflect a light beam include a deflector in which two galvano deflectors each having a mirror are orthogonally disposed. In such a two-dimensional light deflector, when the light beam is actually two-dimensionally deflected, the locus of the light beam is distorted on an image plane.

U.S. Pat. No. 4,838,632 discloses a two-dimensional light deflector with such reduced distortion. FIG. 18 and FIG. 19 show a two-dimensional light deflector disclosed in U.S. Pat. No. 4,838,632. FIG. 18 is a side view of the two-dimensional light deflector, and FIG. 19 is a front view of the two-dimensional light deflector. As shown in FIG. 18 and FIG. 19, a two-dimensional light deflector 500 includes a first deflector 510 and a second deflector 520. The first deflector 510 includes a movable plate 512 having a reflecting face and a bracket 514 that oscillatably supports the movable plate 512 around a first axis A₁. The second deflector 520 causes the first deflector 510 to oscillate around a second axis A₂ orthogonal to the first axis A₁. The first deflector 510 is fixed to the second deflector 520 so that the reflecting face of the movable plate 512 at the time of non-deflection is at an angle of 45 degrees with respect to the second axis A₂. A light beam LB₁ to be deflected falls on the first deflector 510 parallel to the second axis A₂. A light beam LB₂ reflected by the reflecting face of the movable plate 512 falls on an image plane 534 through a lens 532.

The two-dimensional light deflector 500 achieves a reduction in the distortion of the trajectory of the light beam on the image plane while being extremely compact with a simple configuration.

### BRIEF SUMMARY OF THE INVENTION

The present invention is directed to a two-dimensional light deflector that deflects a collimated light beam two-dimensionally. The two-dimensional light deflector includes a first deflector that deflects the collimated light beam in a plane, a second deflector that deflects the collimated light beam in another plane, and a fixing member directly fixing both the first deflector and the second deflector. The first deflector includes a light radiating portion that generates the collimated light beam from light guided by a light guide and radiates it. The light radiating portion is supported oscillatably around a first axis extending outside of the light radiating portion, and radiates the collimated light beam toward the first axis along a first plane perpendicular to the first axis, so that an oscillation of the light radiating portion causes deflection of the collimated light beam along the first plane. The second deflector includes an oscillatable reflecting face that reflects the collimated light beam radiated from the light radiating portion. The reflecting face is inclined by 45 degrees with respect to a plane including the first axis at a time of non-oscillation, and is also inclined by 45 degrees with respect to a plane including a second axis that coincides with a principal ray of the collimated light beam radiated from the light radiating portion at the time of non-oscillation, so that the reflecting face converts deflection of the collimated light beam in the first plane into deflection of the collimated light beam along a second plane perpendicular to the second axis. The reflecting face is also oscillatably supported around a third axis passing through an intersection of the first axis and the second axis, and perpendicular to both the first axis and the second axis, so that an oscillation of the reflecting face around the third axis causes deflection of the collimated light beam in a third plane perpendicular to the third axis.

Advantages of the invention will be set forth in the description that follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a two-dimensional light deflector according to a first embodiment of the present invention.

FIG. 2 is a side view of the two-dimensional light deflector according to the first embodiment of the present invention.

FIG. 3 is a top view of the two-dimensional light deflector according to the first embodiment of the present invention.

FIG. 4 shows a configuration example of a light radiating portion and a cladding fixing portion.

FIG. 5 shows another configuration example of the light radiating portion and the cladding fixing portion.

FIG. 6 shows a deflection of a collimated light beam in a second plane caused by oscillation of the light radiating portion.

FIG. 7 shows the deflection of the collimated light beam in a third plane caused by oscillation of a reflecting face.

FIG. 8 shows a two-dimensional deflection of the collimated light beam by a combination of the oscillation of the light radiating portion and the oscillation of the reflecting face.

FIG. 9 is a perspective view of a movable plate and hinges of a first deflector.

FIG. 10 is a side view of the movable plate and a hinge shown in FIG. 9.

FIG. 11 is a perspective view of a two-dimensional light deflector according to a modified example of the first embodiment of the present invention.

FIG. 12 is a side view of a two-dimensional light deflector according to a second embodiment of the present invention.

FIG. 13 is a top view of the two-dimensional light deflector according to the second embodiment of the present invention.

FIG. 14 is a side view of a two-dimensional light deflector according to a third embodiment of the present invention.

FIG. 15 shows a top view of the two-dimensional light deflector according to the third embodiment of the present invention.

FIG. 16 is a side view of a two-dimensional light deflector according to a modified example of the third embodiment of the present invention.

FIG. 17 is a top view of the two-dimensional light deflector according to the modified example of the third embodiment of the present invention.

FIG. 18 shows a side view of a conventional two-dimensional light deflector disclosed in U.S. Pat. No. 4,838,632.

FIG. 19 shows a top view of the conventional two-dimensional light deflector disclosed in U.S. Pat. No. 4,838,632.

### DETAILED DESCRIPTION OF THE INVENTION

### First Embodiment

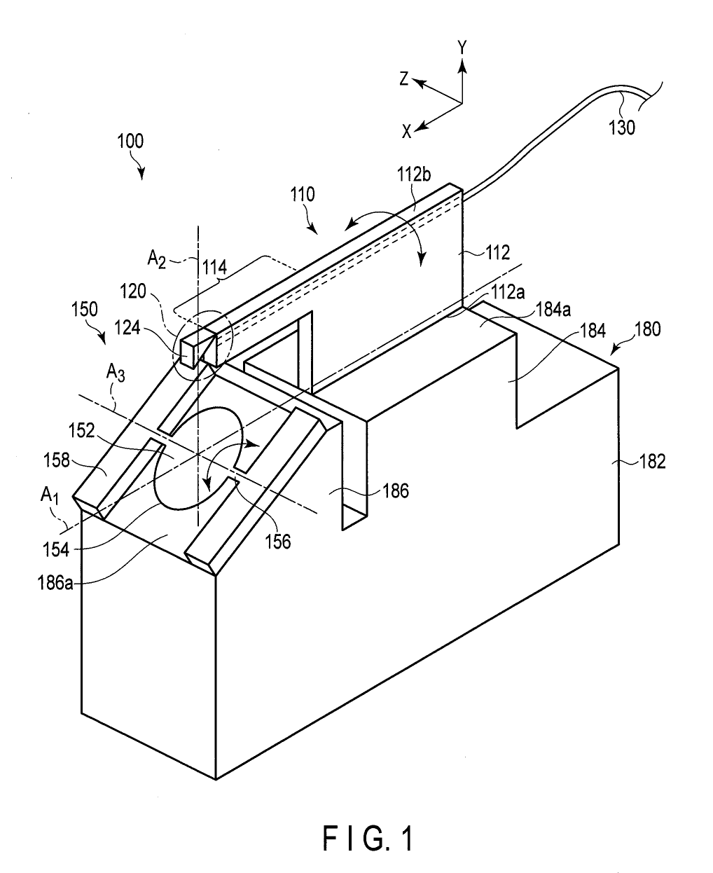

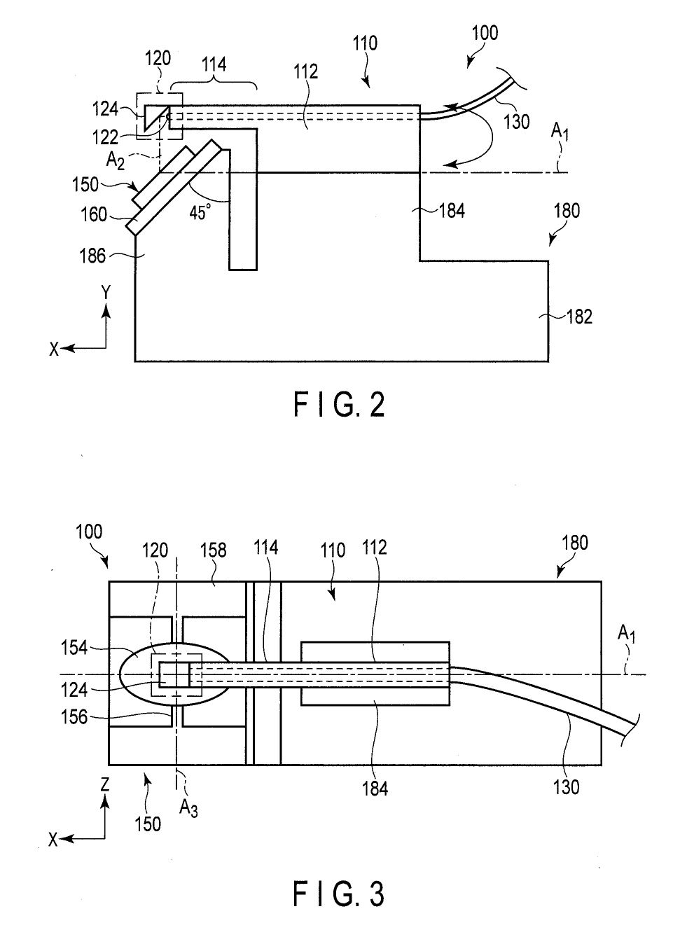

FIG. 1, FIG. 2, and FIG. 3 respectively show a perspective view, a side view, and a top view of a two-dimensional light deflector 100 according to a first embodiment of the present invention. In the following explanation, a positional relationship, directions, and the like of each element will be explained in accordance with an XYZ-orthogonal coordinate system shown in FIG. 1. In addition, for the sake of convenience, according to FIG. 1, it is assumed that a +Y direction is an upward direction, a −Y direction a downward direction, the +X direction a frontward direction, and a −X direction a rearward direction. Furthermore, it is assumed that a plane parallel to a ZX-plane is a horizontal plane.

The two-dimensional light deflector 100 is an optical device that deflects a collimated light beam two-dimensionally, and comprises a first deflector 110 that deflects the collimated light beam in a plane, for example, along a YZ-plane, a second deflector 150 that deflects the collimated light beam in another plane, for example, along an XY-plane, and a fixing member 180 directly fixing both the first deflector and the second deflector.

The fixing member 180 has two convex portions protruding upward from a base 182, a first deflector fixing stand 184 and a second deflector fixing stand 186. The first deflector fixing stand 184 has a first deflector fixing face 184a to which the first deflector 110 is fixed, the first deflector fixing face 184a being parallel to the ZX-plane. On the other hand, the second deflector fixing stand 186 has a second deflector fixing face 186a to which the second deflector 150 is fixed, the second deflector fixing face 186a being declined 45 degrees around the Z-axis with respect to the ZX-plane. Here, the expression 45 degrees includes a range in which a functional difference does not substantially occur.

The first deflector 110 comprises a light radiating portion 120 that generates and radiates a collimated light beam from light guided by an optical fiber 130, which is a light guide, and a cantilever 112 supporting the light radiating portion 120 oscillatably around the first axis A₁ extending outside the light radiating portion 120. Although not shown, the first deflector 110 also includes a drive mechanism or a drive for oscillatably driving the cantilever 112. For driving the drive, any publicly-known drive such as an electromagnetic drive, an electrostatic drive, a piezoelectric drive, or the like may be adapted.

The cantilever 112 is fixed to the first deflector fixing face 184a of the first deflector fixing stand 184 of the fixing member 180 in a cantilever fashion. The first axis A₁ extends through a fixed end 112a of the cantilever 112. The cantilever 112 has an extension 114 extending parallel to the first axis A₁ near its free end 112b, and the light radiating portion 120 is provided at a distal end of the extension 114. The light radiating portion 120 radiates a collimated light beam towards the first axis A₁ along the YZ-plane that is perpendicular to the first axis A₁. Accordingly, the oscillation of the light radiating portion 120 around the first axis A₁ causes deflection of the collimated light beam along the YZ-plane. Furthermore, the collimated light beam radiated from the light radiating portion 120 always passes through the first axis A₁.

The second deflector 150 has an oscillatable reflecting face 152 that reflects the collimated light beam radiated from the light radiating portion 120. The reflecting face 152 is inclined by 45 degrees with respect to the ZX-plane including the first axis A₁ at the time of non-oscillation. The reflecting face 152 is also inclined by 45 degrees with respect to the YZ-plane including a second axis A₂ that coincides with a principal ray of the collimated light beam radiated from the light radiating portion 120 at the time of non-oscillation. Accordingly, the reflecting face 152 converts the deflection of the collimated light beam in the YZ-plane into a deflection of the collimated light beam along the XY-plane that is perpendicular to the second axis A₂.

Furthermore, the reflecting face 152 is oscillatably supported around a third axis A₃ passing through an intersection of the first axis A₁ and the second axis A₂, and perpendicular to both the first axis A₁ and the second axis A₂. Accordingly, the oscillation of the reflecting face 152 around the third axis A₃ causes deflection of the collimated light beam along the XY-plane perpendicular to the third axis A₃.

Therefore, the combination of the oscillation of the light radiating portion 120 around the first axis A₁ and the oscillation of the reflecting face 152 around the third axis A₃ deflects the collimated light beam two-dimensionally along the YZ-plane.

The second deflector 150 is configured by, for example, a MEMS deflector. The second deflector 150 configured by the MEMS deflector comprises a movable plate 154 provided with the reflecting face 152, a pair of hinges 156 supporting the movable plate 154 oscillatably around the third axis A₃, and a pair of supports 158 supporting the hinges 156. The supports 158 are fixed to the second deflector fixing face 186a of the second deflector fixing stand 186 through a spacer 160. As a result, the movable plate 154 is oscillatably supported apart from the second deflector fixing face 186a. Although not shown, the second deflector 150 also comprises a drive mechanism or a drive for oscillatably driving the movable plate 154. For driving the drive, any publicly-known drive such as an electromagnetic drive, an electrostatic drive, a piezoelectric drive, or the like may be adapted. Since an actual MEMS deflector is provided with a drive, it is easily expected that the MEMS deflector is more complicated and larger than the illustrated configuration.

The second deflector 150 configured by the MEMS deflector is used as a high-speed scanning side in a raster scan. In high-speed scanning, adopting resonance driving, which can utilize a gain of a Q value, can further reduce power consumption. In addition, since a main material of the second deflector 150 is manufactured by MEMS technology, in many cases, a silicon substrate is used as the main material. However, for the hinges 156, a silicon compound such as silicon nitride, or an organic material such as polyimide may be adapted as well silicon. In addition, in the drawing, each hinge 156 has a straight shape, but may also be configured by a bending hinge or the like.

As shown in FIG. 2, the height of the first deflector fixing face 184a of the first deflector fixing stand 184 is designed so as to be exactly the same as an oscillation axis of the reflecting face 152 of the second deflector 150. As shown in FIG. 3, the cantilever 112 is disposed so that, when the center of the thickness of the cantilever 112 (in the Z-axis direction) is extended in the direction of the second deflector 150, the center line of the thickness of the cantilever 112 crosses the center of the reflecting face 152 of the second deflector 150. This design has a desirable positional relationship from the viewpoint of reducing the moment of inertia (speeding up) of the movable plate 154 of the second deflector 150.

As shown in FIG. 2, the length (the dimension in the Y-axis direction) of the cantilever 112 is designed so that the height of the free end 112b of the cantilever 112 is higher than the height of the second deflector fixing face 186a. The extension 114 provided near the free end 112b of the cantilever 112 extends frontward, that is, in the +X direction toward the second deflector 150. The light radiating portion 120 provided at the end of the extension 114 is located above the reflecting face 152 of the second deflector 150, that is, in the +Y direction.

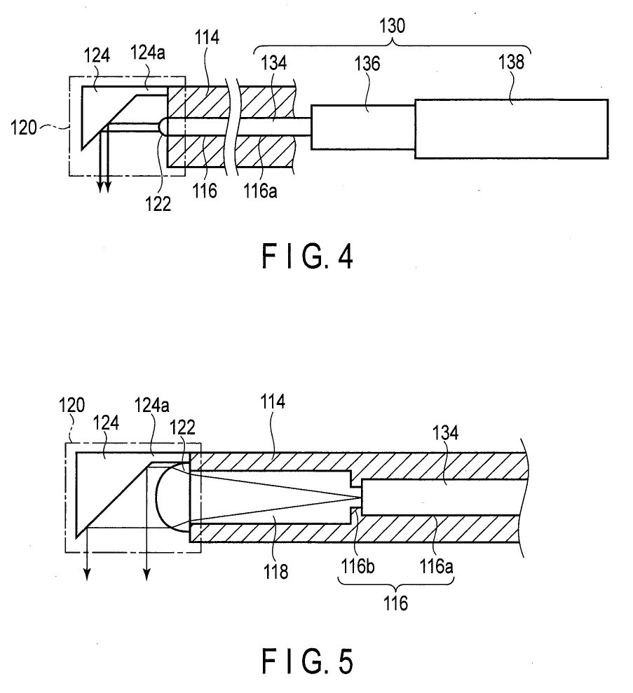

As shown in FIG. 4, the cantilever 112, in particular the extension 114, includes a cladding fixing portion 116 fixing a cladding 134 of the optical fiber 130. The cladding fixing portion 116 has a cavity 116a in which the cladding 134 of the optical fiber 130 is fitted and is accommodated. The cavity 116a extends parallel to the first axis A₁. The cavity 116a is configured by, for example, a groove or a through hole. The cladding 134 of the optical fiber 130 is fixed to the groove or the through hole by adhesion.

The portion of the optical fiber 130 inserted into the cavity 116a of the cladding fixing portion 116 is a cladding 134 from which a jacket 138 and a coating portion 136 are stripped off of the optical fiber 130. Since the diameter of the coating portion 136 and the jacket 138 of the optical fiber 130 has a large tolerance, if the diameter of the cavity 116a is increased in accordance with the diameter of the coating portion 136 and the jacket 138, it would be difficult for the optical fiber 130 to be fixed while achieving good reproducibility of a light radiating direction from the optical fiber 130. On the other hand, since the tolerance of the diameter of the cladding 134 is smaller than that of the coating portion 136 and the jacket 138, the diameter of the cavity 116a can be appropriately designed; high reproducibility of the light radiating direction from the optical fiber 130 can be obtained.

As shown in FIG. 4 and FIG. 5, the light radiating portion 120 comprises a collimating lens 122 that shapes the light radiated from the optical fiber 130 into a collimated light beam. Accordingly, the collimated light beam is radiated from the collimating lens 122 along the first axis A₁. The light radiating portion 120 further comprises a prism 124 that deflects the collimated light beam radiated from the collimating lens 122 along the first axis A₁ toward the reflecting face along the second axis A₂. The prism 124 is fixed to the extension 114 through a prism attaching portion 124a.

The collimating lens 122 is fixed directly to the optical fiber 130 as shown in, for example, FIG. 4. As shown in FIG. 5, it may be configured that the cladding fixing portion 116 includes an optical fiber positioning part 116b that has a smaller diameter than that of the cavity 116a at the front end of the cavity 116a, the extension 114 further includes a propagating portion 118 with a diameter that would not affect the light radiated from the optical fiber 130 at the front of the optical fiber positioning part 116b, and the collimating lens 122 is attached to the distal end of the extension 114, which is the front end of the propagating portion 118. In this case, the optical fiber positioning part 116b and the propagating portion 118 are designed so as to have a diameter that would not affect the light radiated from the optical fiber 130.

In FIG. 1 to FIG. 3, in the two-dimensional light deflector 100 configured in the manner above, the light radiated from the optical fiber 130 is converted into a collimated light beam by the collimating lens 122 while traveling in the +X-axis direction, subsequently reflected by the prism 124 and deflected in the −Y-axis direction, and then reaches the reflecting face 152 of the second deflector 150.

The cantilever 112 oscillates around the first axis A₁ that is parallel to the X-axis and passes through the first deflector fixing face 184a. Since the first deflector fixing face 184a is at the same height as the oscillation axis of the reflecting face 152 of the second deflector 150, although a traveling direction of the collimated light beam reflected by the prism 124 changes in response to the oscillation of the cantilever 112, the collimated light beam reflected by the prism 124 always travels toward an intersection of the first axis A₁ and the third axis A₃. Subsequently, the collimated light beam is reflected frontward, that is, in the +X direction by the reflecting face 152 that is disposed at the intersection of the first axis A₁ and the third axis A₃. The collimated light beam reflected by the reflecting face 152 is deflected in the second plane by the oscillation of the light radiating portion 120, and is deflected in the third plane by the oscillation of the reflecting face 152.

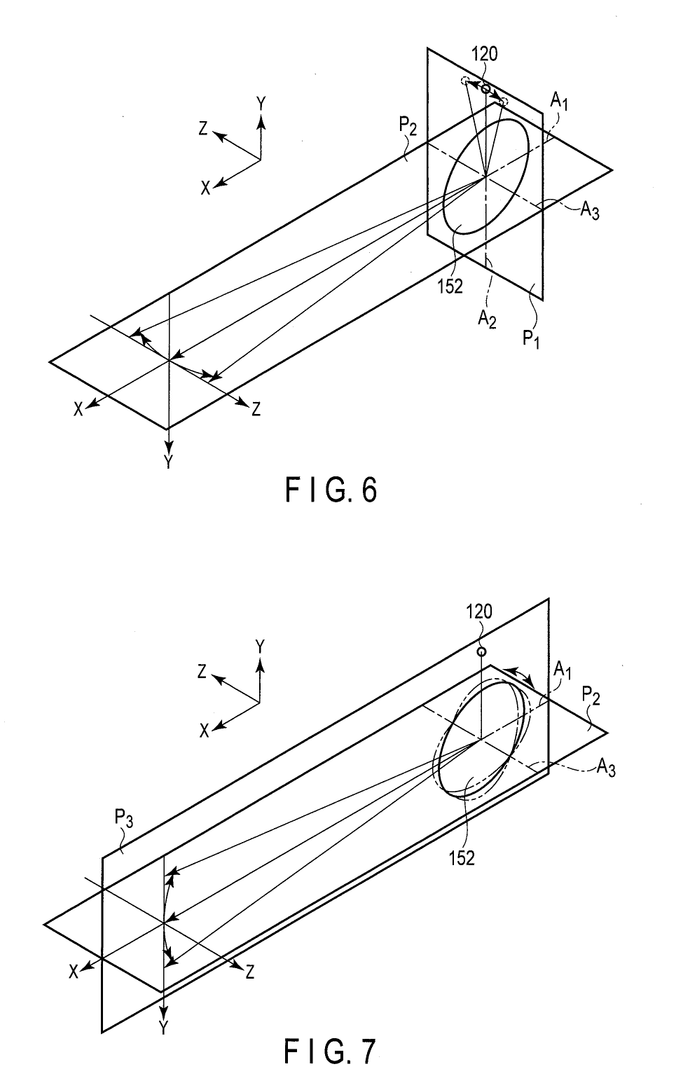

Hereinafter, a deflection operation of the collimated light beam in the two-dimensional light deflector 100 will be explained in detail with reference to FIG. 6 to FIG. 8. In the following explanation, a plane perpendicular to the first axis A₁ is referred to as a first plane P₁, a plane perpendicular to the second axis A₂ is referred to as a second plane P₂, and a plane perpendicular to the third axis A₃ is referred to as a third plane P₃.

The light radiating portion 120 is disposed on the first plane P₁ in an oscillatable manner around the first axis A₁. When oscillating, the light radiating portion 120 reciprocates in a predetermined angular range on a circumference having a constant radius from the first axis A₁. Since the light radiating portion 120 radiates the collimated light beam toward the first axis A₁ on the first plane P₁, the collimated light beam radiated from the light radiating portion 120 always reaches an intersection of the first axis A₁ and the first plane P₁. The reflecting face 152 is disposed on the intersection of the first axis A₁ and the first plane P₁. The reflecting face 152 is disposed in an oscillatable manner around the third axis A₃. The third axis A₃ passes through the intersection of the first axis A₁ and the first plane P₁ and extends perpendicularly to both the first axis A₁ and the second axis A₂. The reflecting face 152 is inclined by 45 degrees with respect to the first plane P₁ around the third axis A₃ at the time of non-oscillation.

The collimated light beam radiated from the light radiating portion 120 at the time of non-oscillation travels along the second axis A₂, falls on the reflecting face 152, and is reflected along the first axis A₁ by the reflecting face 152 at the time of non-oscillation.

As shown in FIG. 6, when the light radiating portion 120 is oscillated around the first axis A₁, the collimated light beam reflected by the reflecting face 152 at the time of non-oscillation is deflected in the second plane P₂.

Furthermore, as shown in FIG. 7, when the reflecting face 152 is oscillated around the third axis A₃, the collimated light beam radiated from the light radiating portion 120 at the time of non-oscillation and reflected by the reflecting face 152 is deflected in the third plane P₃.

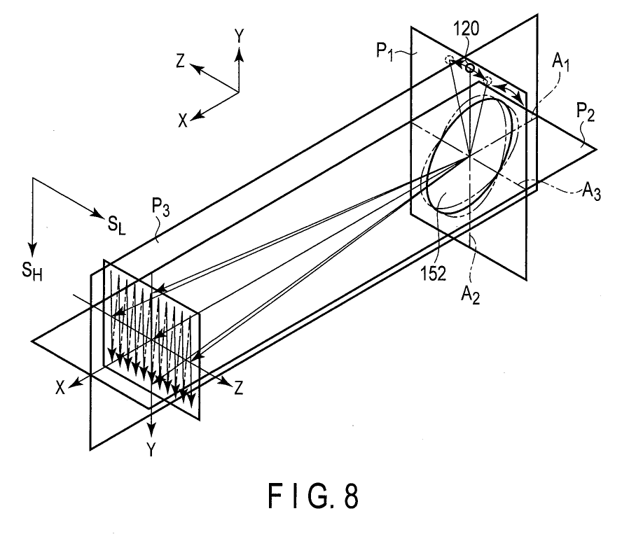

Accordingly, combining the oscillation of the light radiating portion 120 around the first axis A₁ and the oscillation of the reflecting face 152 around the third axis A₃ allows the collimated light beam reflected by the reflecting face 152 to be two-dimensionally scanned, as shown in FIG. 8.

Now, a case in which a raster scan is performed using the two-dimensional light deflector 100 will be explained. Here, the first deflector 110 is adapted for a low-speed scan and the second deflector 150 is adapted for a high-speed scan. The collimated light beam radiated from the light radiating portion 120 and reflected by the reflecting face 152 is scanned in a low-speed scan SL direction shown in FIG. 8 by the oscillation of the light radiating portion 120. The collimated light beam radiated from the light radiating portion 120 and reflected by the reflecting face 152 is scanned in a high-speed scan SH direction shown in FIG. 8 by the oscillation of the reflecting face 152. Combining the oscillation of the light radiating portion 120 and the oscillation of the reflecting face 152 allows the collimated light beam to be raster-scanned. In this case, the oscillation frequency is assumed to be, for example, 4 kHz or 8 kHz for the high-speed scan and 15 Hz to 60 Hz for the low-speed scan.

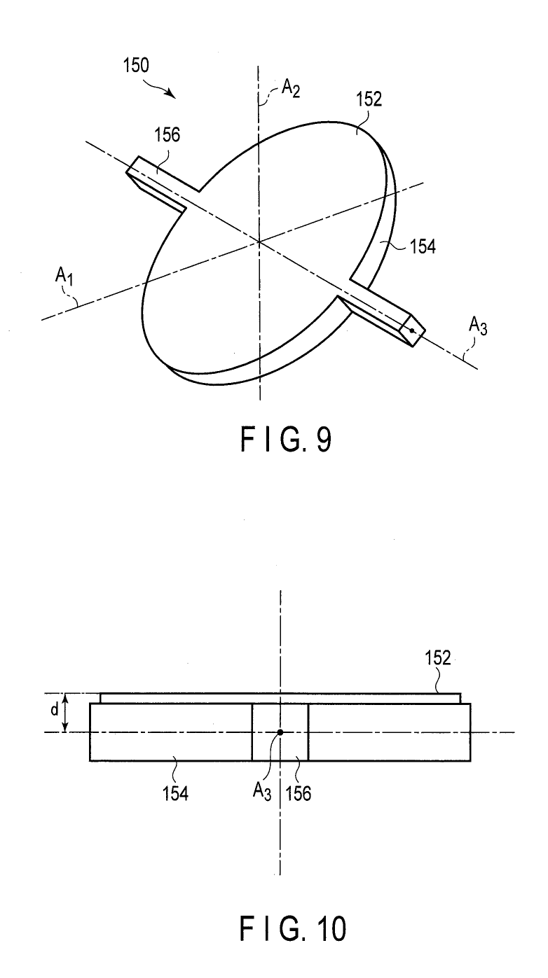

Here, the third axis A₃, which is the oscillation axis of the reflecting face 152 of the second deflector 150, is not exactly on the reflecting face 152 of the second deflector 150, but is located at the center of a cross-section of the hinges 156, so that there is an offset d between the third axis A₃ and the reflecting face 152, as shown in FIG. 9 and FIG. 10. However, since the thickness of the hinges 156 of the second deflector 150 manufactured by the MEMS technology is generally small, this offset d can be ignored in reality. That is, in the present specification, the reflecting face's 152 oscillating around the third axis A₃ allows the reflecting face 152 to oscillate around the third axis A₃ off the reflecting face 152 within a range that would cause no defects.

Although the two-dimensional light deflector 100 of the present embodiment is not configured in a manner that a deflector is mounted on another deflector as in the two-dimensional light deflector 500 of the conventional example disclosed in U.S. Pat. No. 4,838,632, a raster scan can be achieved with a substantially rectangular scanning surface in the same manner as the two-dimensional light deflector 500 of the conventional example. On the other hand, since the elements mounted on the cantilever 112 are only the optical fiber 130, the collimating lens 122, and the prism 124, which are compact and lightweight, the moment of inertia of the cantilever 112 is greatly reduced as compared to the two-dimensional light deflector 500 of the conventional example. Therefore, even when securing the same responsiveness as the two-dimensional light deflector 500 of the conventional example, the driving force required thereby is greatly reduced, so that the power consumption required for oscillation is greatly reduced. In addition, as the driving force is reduced, the volume required for driving is also reduced, which enables to achieve significant downsizing from the two-dimensional light deflector 500 of the conventional example.

### Modified Example

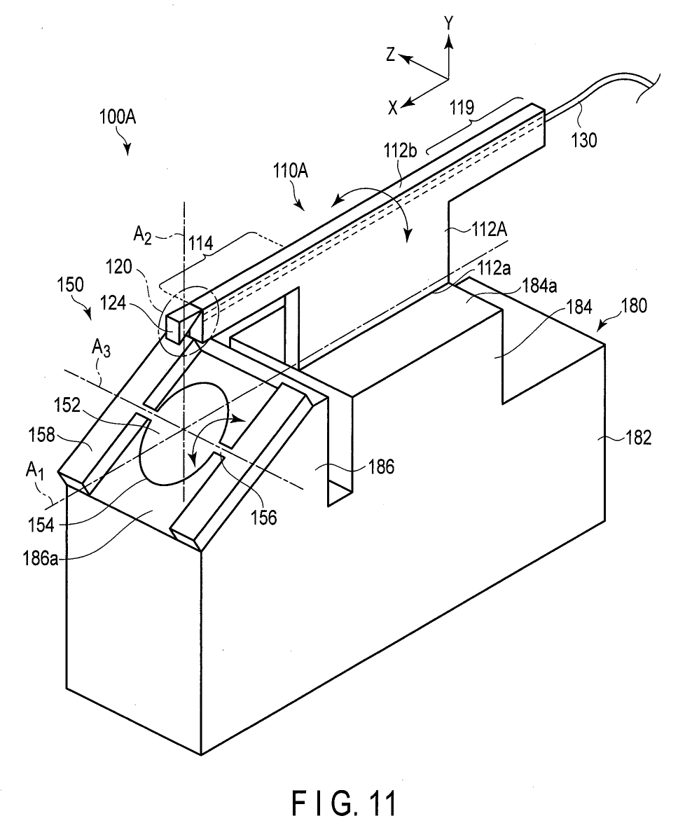

FIG. 11 shows a modified example of the first embodiment. In the two-dimensional light deflector 100 shown in FIG. 1, since the cantilever 112 has the extension 114 on one side, the extension 114 may move unexpectedly due to an impact or the like by an external force. A two-dimensional light deflector 100A of the present modified example includes, as shown in FIG. 11, a cantilever 112A that has an adjusting extension 119 extending parallel to a first axis A₁ in a direction opposite to an extension 114 near its free end. The adjusting extension 119 has the same mechanical characteristics as the extension 114. For example, the adjusting extension 119 has the same length and the same mass as the extension 114. As described above, since the cantilever 112A has the adjusting extension 119 similar to the extension 114 on the opposite side of the extension 114, the balance against vibration etc. is improved, so that the cantilever 112A is strong against an external impact.

### Second Embodiment

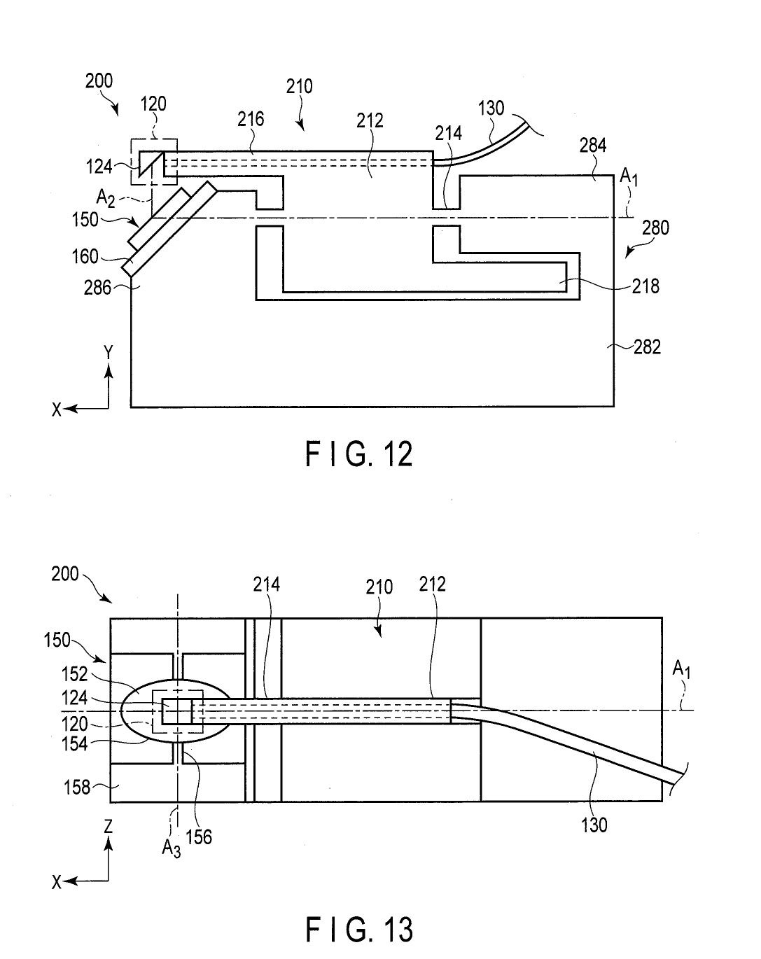

FIG. 12 and FIG. 13 respectively show a side view and a top view of a two-dimensional light deflector according to a second embodiment of the present invention. In FIG. 12 and FIG. 13, members denoted by the same reference numerals as those shown in FIG. 1 to FIG. 3 are the same members, for which detailed explanations will be omitted. The following explanations will be provided while placing importance on the parts different from those in FIG. 1 to FIG. 3. That is, portions not mentioned in the following explanation are the same as those in the first embodiment.

In the first embodiment, the mechanism that oscillates the light radiating portion 120 is configured using the cantilever; however, in the present embodiment, the mechanism is configured using a movable plate.

A two-dimensional light deflector 200 comprises a first deflector 210 that deflects a collimated light beam in a plane, for example, along the YZ-plane, the second deflector 150 that deflects the collimated light beam in another plane, for example, along the XY-plane, and a fixing member 280 directly fixing both the first deflector and the second deflector.

The fixing member 280 includes two convex portions protruding upward from a base 282, a support 284 and a second deflector fixing stand 286. The second deflector fixing stand 286 has the same configuration as the second deflector fixing stand 186 of the first embodiment. In other words, a second deflector fixing face of the second deflector fixing stand 286 is inclined by 45 degrees with respect to the YZ-plane around a Z-axis. The second deflector 150 is as explained in the first embodiment.

The first deflector 210 comprises two torsion hinges 214 extending from the fixing member 280 along the first axis A₁, an oscillation member 212 supported by the torsion hinges 214, and the light radiating portion 120 attached to the oscillation member 212. The configuration of the light radiating portion 120 is as explained in the first embodiment. Although not shown, the first deflector 210 also comprises a drive mechanism or a drive for oscillatably driving the oscillation member 212. For driving the drive, any publicly-known drive such as an electromagnetic drive, an electrostatic drive, a piezoelectric drive, or the like may be adapted.

One torsion hinge 214 extends from the support 284 of the fixing member 280 along the first axis A₁, while the other torsion hinge 214 extends from the second deflector fixing stand 286 along the first axis A₁. The two torsion hinges 214 are disposed coaxially so that their center axes are aligned with each other. The two torsion hinges 214 oscillatably support the oscillation member 212 around the first axis A₁ with respect to the fixing member 280.

The oscillation member 212 has an extension 216 extending frontward, that is, in a +X direction parallel to the first axis A₁, at the end on the upper side, that is, on a +Y direction side, and the light radiating portion 120 is provided at the distal end of the extension 216. As in the first embodiment, the extension 216 has a cladding fixing portion fixing a cladding of an optical fiber 130, which is a light guide. Although not shown, the cladding fixing portion provided in the extension 216 has the same structure as the cladding fixing portion 116 explained in the first embodiment.

The oscillation member 212 further has an adjusting extension 218 extending parallel to the first axis A₁ in the backward direction, that is, in a −X direction, and parallel to the first axis A₁ in a direction opposite to the extension 216, at the end on the lower side, that is, on the side in a −Y direction. The adjusting extension 218 has the same mechanical characteristics as the extension 216. The extension 216 and the adjusting extension 218 are symmetrically disposed with respect to a point on the first axis A₁. That is, the extension 216 and the adjusting extension 218 are positioned on opposite sides with reference to the first axis A₁, and extend in mutually opposite directions.

Since the adjusting extension 218 is also formed at the end of the oscillation member 212 on the side opposite to the side on which the light radiating portion 120 is provided in the above manner, the oscillation member 212 is configured to have the same moment of inertia on both sides thereof, with the center at the center axis of the torsion hinge 214.

In the two-dimensional light deflector 200 of the present embodiment, the oscillation axis of the first deflector 210 extends on the first axis A₁, the oscillation axis of the reflecting face 152 of the second deflector 150 is located on the third axis A₃, and the third axis A₃ crosses through a point on the first axis A₁ and extends perpendicular to the first axis A₁.

Similar to the two-dimensional light deflector 100 of the first embodiment, in the two-dimensional light deflector 200 of the present embodiment, such configuration allows the collimated light beam radiated from the light radiating portion 120 to always fall on the reflecting face 152 of the second deflector 150 on its oscillation axis. The collimated light beam reflected by the reflecting face 152 of the second deflector 150 is deflected along the YZ-plane by the oscillation member 212 of the first deflector 210 oscillating around the first axis A₁, and is deflected along the XY-plane by the reflecting face 152 of the second deflector 150 oscillating around the third axis A₃.

In the same manner as in the two-dimensional light deflector 100 of the first embodiment, the two-dimensional light deflector 200 of the present embodiment can achieve a raster scan with a substantially rectangular scanning surface, in the same manner as in the two-dimensional light deflector 500 of the conventional example, in which a deflector is mounted on another deflector, disclosed in U.S. Pat. No. 4,838,632. On the other hand, since the elements mounted on the oscillation member 212 are only the optical fiber 130, the collimating lens 122, and the prism 124, which are compact and lightweight, the moment of inertia of the oscillating member 212 is greatly reduced as compared to the two-dimensional light deflector 500 of the conventional example. Therefore, even when securing the same responsiveness as the two-dimensional light deflector 500 of the conventional example, the driving force required thereby is greatly reduced, so that the power consumption required for oscillation is greatly reduced. In addition, as the driving force is reduced, the volume required for driving is also reduced, which enables to achieve significant downsizing from the two-dimensional light deflector 500 of the conventional example.

Furthermore, the two-dimensional light deflector 200 of the present embodiment has a configuration that is more robust against external forces than the two-dimensional light deflector 100 of the first embodiment. In the case where the first deflector 110 includes the cantilever 112 as in the first embodiment, strong vibration from the outside may cause unexpected oscillation of the collimated light beam from the optical fiber 130. On the contrary, in the present embodiment, since the oscillation member 212 is balanced with the same moment of inertia on both sides, with the torsion hinge 214 at the center, it is difficult for unexpected oscillation to occur due to external vibration. Therefore, the two-dimensional light deflector 200 according to the present embodiment, in which the first deflector 210 includes the oscillation member 212, has a configuration with higher robustness against external forces as compared to the two-dimensional light deflector 100 of the first embodiment, in which the first deflector 110 includes the cantilever 112.

### Third Embodiment

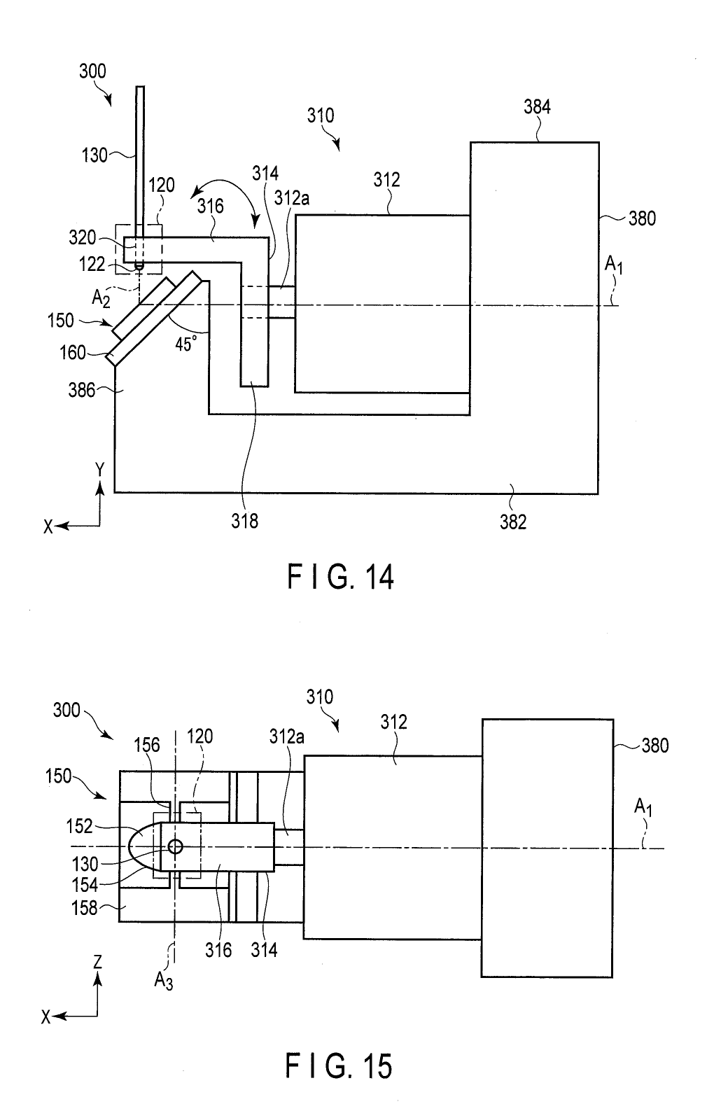

FIG. 14 and FIG. 15 respectively show a side view and a top view of a two-dimensional light deflector according to a third embodiment of the present invention. In FIG. 14 and FIG. 15, members denoted by the same reference numerals as those shown in FIG. 1 to FIG. 3 are the same members, for which detailed explanations will be omitted. The following explanations will be provided while placing importance on the parts different from those in FIG. 1 to FIG. 3. That is, portions not mentioned in the following explanation are the same as those in the first embodiment.

A two-dimensional light deflector 300 of the present embodiment comprises a galvano deflector 312 in the same manner as the two-dimensional light deflector 500 of the conventional example disclosed in U.S. Pat. No. 4,838,632. However, the second deflector 150 is not mounted on the galvano deflector 312.

The two-dimensional light deflector 300 comprises a first deflector 310 that deflects a collimated light beam in a plane, for example, along the YZ-plane, the second deflector 150 that deflects the collimated light beam in another plane, for example, along the XY-plane, and a fixing member 380 directly fixing both the first deflector and the second deflector.

The fixing member 380 includes two convex portions protruding upward from a base 382, a first deflector fixing stand 384 and a second deflector fixing stand 386. The second deflector fixing stand 386 has the same configuration as the second deflector fixing stand 186 of the first embodiment. That is, a second deflector fixing face of the second deflector fixing stand 386 is inclined by 45 degrees with respect to the YZ-plane around the Z-axis. The second deflector 150 is as explained in the first embodiment.

The first deflector 310 comprises the galvano deflector 312 fixed to the first deflector fixing stand 384. The galvano deflector 312 has a rotating shaft 312a that is oscillatable around the first axis A₁. The first deflector 310 further comprises an optical fiber fixing jig 314 fixing an optical fiber, which is a light guide attached to the rotating shaft 312a of the galvano deflector 312, and the light radiating portion 120 provided on the optical fiber fixing jig 314.

The optical fiber fixing jig 314 has an extension 316 extending parallel to the first axis A₁. The light radiating portion 120 is provided at a distal end of the extension 316. The light radiating portion 120 includes the optical fiber 130 inserted and fixed in a through hole formed at the distal end of the extension 316, and the collimating lens 122 provided at a distal end of the optical fiber 130.

Although not shown in detail in FIG. 14 and FIG. 15, the extension 316 includes a cladding fixing portion 320 fixing the cladding of the optical fiber 130. As in the first embodiment, the cladding fixing portion 320 has a cavity in which the cladding of the optical fiber 130 is fitted and is accommodated. The cavity is configured by, for example, a groove or a through hole. The optical fiber 130 is fixed to the optical fiber fixing jig 314 by inserting the cladding into the cavity formed in the extension 316 and then adhering the same. The cavity in which the cladding of the optical fiber 130 is accommodated penetrates a distal end of the extension 316, and extends toward the first axis A₁. Therefore, the collimated light beam radiated from the light radiating portion 120 always passes through the first axis A₁.

The optical fiber fixing jig 314 further has an adjusting extension 318 on a portion opposite to the extension 316 with reference to the first axis A₁. The adjusting extension 318 has the same mechanical characteristics as the extension 316, for example, the weight, and is designed so that the moment of inertia is balanced with the center at an oscillation axis. The adjusting extension 318 may be of course adjusted in the moment of inertia by changing the thickness.

The second deflector 150 is disposed so that the oscillation axis of the reflecting face 152 crosses through a point on the first axis A₁. Therefore, the collimated light beam radiated from the optical fiber 130 is configured to falls on an intersection point of the oscillation axis of the galvano deflector 312 and the oscillation axis of the second deflector 150. Although a direction in which the collimated light beam falls on the reflecting face 152 of the second deflector 150 varies depending on the oscillation of the galvano deflector 312, a position on the reflecting face 152 of the second deflector 150 on which the collimated light beam falls does not change. The collimated light beam reflected by the reflecting face 152 of the second deflector 150 is deflected along the ZX-plane by the first deflector 310, that is, by an oscillation of the optical fiber fixing jig 314, and is deflected along an XY-plane by the second deflector 150, that is, by an oscillation of the reflecting face 152. Therefore, combining these oscillations allows the collimated light beam reflected by the reflecting face 152 of the second deflector 150 to be two-dimensionally scanned. Here, the galvano deflector 312 is adapted for a low-speed scan and the second deflector 150 is adapted for a high-speed scan, which achieves a favorable raster scan.

With the above configuration, in the same manner as the first and second embodiments, a raster scan with a substantially rectangular scanning surface can be achieved in the same manner as the two-dimensional light deflector 500 of the conventional example, in which a deflector is mounted on another deflector, disclosed in U.S. Pat. No. 4,838,632. On the other hand, since the elements mounted on the galvano deflector 312 are only the optical fiber fixing jig 314, the optical fiber 130, and the collimating lens 122, which are small and lightweight, the moment of inertia applied to the rotating shaft 312a of the galvano deflector 312 is greatly reduced as compared to the two-dimensional light deflector 500 of the conventional example. Therefore, even when securing the same responsiveness as the two-dimensional light deflector 500 of the conventional example, the driving force required thereby is greatly reduced, so that the power consumption required for oscillation is greatly reduced.

The configuration of the two-dimensional light deflector 300 according to the present embodiment is close to the configuration of the conventional two-dimensional light deflector 500 of the conventional example, in which a second deflector is disposed on a galvano deflector. Furthermore, the galvano deflector 312 is generally commercially available, and it is easy to switch from the configuration in which the second deflector is disposed on the galvano deflector.

### Modified Example

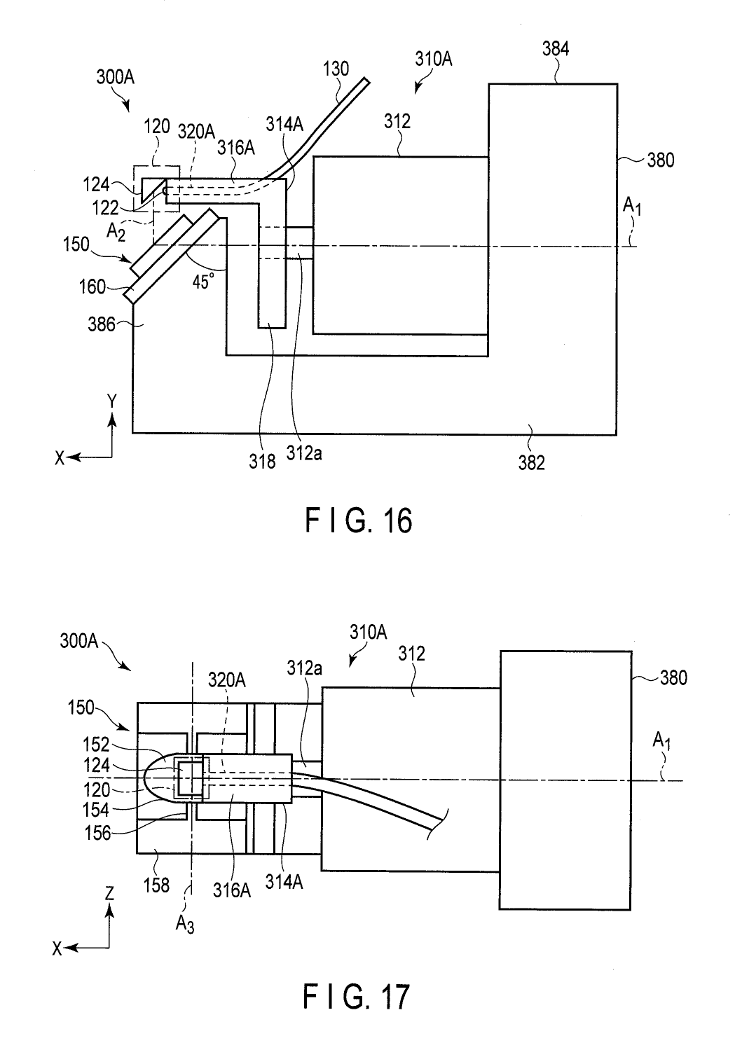

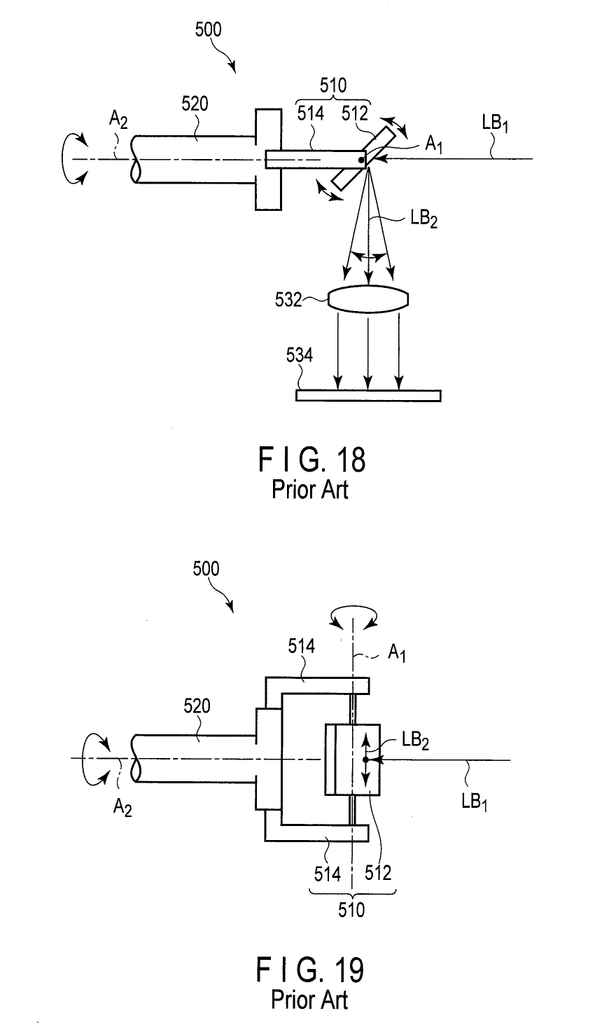

FIG. 16 and FIG. 17 respectively show a side view and a front view of a modified example of the third embodiment of the present invention. In FIG. 16 and FIG. 17, members denoted by the same reference numerals as those shown in FIG. 14 and FIG. 15 are the same members; therefore, a detailed explanation thereof will be omitted. The following explanations will be provided while placing importance on the parts different from those in FIG. 14 and FIG. 15.

A two-dimensional light deflector 300A of the present modified example is provided with a first deflector 310A instead of the first deflector 310 shown in FIG. 14 and FIG. 15. The first deflector 310A comprises an optical fiber fixing jig 314A instead of the optical fiber fixing jig 314 shown in FIG. 14 and FIG. 15.

In the two-dimensional light deflector 300A of the present modified example, the optical fiber fixing jig 314A has an extension 316A extending parallel to the first axis A₁. A light radiating portion 120 is provided at a distal end of the extension 316A.

Although not shown in detail in FIG. 16 and FIG. 17, the extension 316A has a cladding fixing portion 320A fixing the cladding of the optical fiber 130. As in the first embodiment, the cladding fixing portion 320A has a cavity in which the cladding of the optical fiber 130 is fitted and is accommodated. The cavity is configured by, for example, a groove or a through hole. The optical fiber 130 is fixed to the optical fiber fixing jig 314A by inserting the cladding into the cavity formed in the extension 316A and then adhering the same. The cavity accommodating the cladding of the optical fiber 130 extends parallel to the first axis A₁ near at least a distal end of the extension 316A.

The light radiating portion 120 comprises the collimating lens 122 that shapes light radiated from the optical fiber 130 into a collimated light beam, and the prism 124 that deflects the collimated light beam radiated from the collimating lens 122 along the first axis A₁ toward a reflecting face along the second axis A₂. The light radiating portion 120 is configured in the same manner as in the first embodiment.

In the two-dimensional light deflector 300A of the present modified example, the cavity 316a for installing the optical fiber 130 is longer than that of the two-dimensional light deflector 300 shown in FIG. 14 and FIG. 15. Therefore, the reproducibility of the direction of the collimated light beam radiated from the optical fiber 130 is improved; the optical fiber 130 can be easily fixed in a desired direction, and the assemblability is improved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A two-dimensional light deflector that deflects a collimated light beam two-dimensionally, comprising:
a first deflector that deflects the collimated light beam in a plane;
a second deflector that deflects the collimated light beam in another plane; and
a fixing member directly fixing both the first deflector and the second deflector,
the first deflector comprising a light radiating portion that generates the collimated light beam from light guided by a light guide and radiates it, the light radiating portion being supported oscillatably around a first axis extending outside of the light radiating portion, and radiating the collimated light beam toward the first axis along a first plane perpendicular to the first axis, whereby an oscillation of the light radiating portion causing deflection of the collimated light beam along the first plane,
the second deflector including an oscillatable reflecting face that reflects the collimated light beam radiated from the light radiating portion, the reflecting face being inclined by 45 degrees with respect to a plane including the first axis at a time of non-oscillation, and being also inclined by 45 degrees with respect to a plane including a second axis that coincides with a principal ray of the collimated light beam radiated from the light radiating portion at the time of non-oscillation, whereby the reflecting face converting deflection of the collimated light beam in the first plane into deflection of the collimated light beam along a second plane perpendicular to the second axis, the reflecting face being also oscillatably supported around a third axis passing through an intersection of the first axis and the second axis, and perpendicular to both the first axis and the second axis, whereby an oscillation of the reflecting face around the third axis causing deflection of the collimated light beam in a third plane perpendicular to the third axis.

2. The two-dimensional light deflector according to claim 1, wherein the second deflector is configured by a MEMS deflector, the MEMS deflector comprising a movable plate provided with the reflecting face and a hinge supporting the movable plate oscillatably around the third axis.

3. The two-dimensional light deflector according to claim 1, wherein the first deflector comprises a cantilever supporting the light radiating portion oscillatably around the first axis, the cantilever being fixed to the fixing member in a cantilever fashion, the first axis extending through a fixed end of the cantilever, the cantilever having an extension extending parallel to the first axis, the light radiating portion being provided at a distal end of the extension, and the extension including a cladding fixing portion fixing a cladding of the light guide.

4. The two-dimensional light deflector according to claim 3, wherein the cantilever has an adjusting extension extending parallel to the first axis in a direction opposite to the extension, and the adjusting extension has the same mechanical characteristics as those of the extension.

5. The two-dimensional light deflector according to claim 3,
wherein the cladding fixing portion has a cavity in which the cladding of the light guide is fitted and accommodated, the cavity extending parallel to the first axis, and
the light radiating portion comprises a collimating lens that shapes the light radiated from the light guide into the collimated light beam, and a prism that deflects the collimated light beam radiated from the collimating lens along the first axis toward the reflecting face along the second axis.

6. The two-dimensional light deflector according to claim 1, wherein the first deflector comprises two torsion hinges extending from the fixing member along the first axis, and an oscillation member oscillatably supported by the torsion hinge around the first axis with respect to the fixing member, the oscillation member having an extension extending parallel to the first axis, the light radiating portion provided at a distal end of the extension, and the extension including a cladding fixing portion fixing a cladding of the light guide.

7. The two-dimensional light deflector according to claim 6, wherein the oscillation member has an adjusting extension extending parallel to the first axis in a direction opposite to the extension, the adjusting extension having the same mechanical characteristics as those of the extension.

8. The two-dimensional light deflector according to claim 3,
wherein the cladding fixing portion includes a cavity in which the cladding of the light guide is fitted and is accommodated, the cavity extending parallel to the first axis, and
the light radiating portion comprises a collimating lens that shapes the light radiated from the light guide into the collimated light beam, and a prism that deflects the collimated light beam radiated from the collimating lens along the first axis toward the reflecting face along the second axis.

9. The two-dimensional light deflector according to claim 1,
wherein the first deflector includes a galvano deflector that includes a rotating shaft oscillatable around the first axis, and a light guide fixing jig attached to the rotary shaft of the galvano deflector, and
the light guide fixing jig has an extension extending parallel to the first axis, the light radiating portion provided at a distal end of the extension, and the extension having a cladding fixing portion fixing a cladding of the light guide.

10. The two-dimensional light deflector according to claim 9, wherein the light guide fixing jig has an adjusting extension on an opposite side of the extension with reference to the rotary shaft, the adjusting extension having the same mechanical characteristics as those of the extension.

11. The two-dimensional light deflector according to claim 9,
wherein the cladding fixing portion includes a cavity in which the cladding of the light guide is fitted and is accommodated, the cavity extending parallel to the first axis, and
the light radiating portion comprises a collimating lens that shapes the light radiated from the light guide into the collimated light beam, and a prism that deflects the collimated light beam radiated from the collimating lens along the first axis toward the reflecting face along the second axis.
